(19) United States
(12) Patent Application Publication
(10) Pub. No.: US 2024/0247871 A1
(43) Pub. Date: Jul. 25, 2024

(54) DRYING NOZZLE

(71) Applicant: Olympus Winter & Ibe GmbH, Hamburg (DE)

(72) Inventors: Lea Melina Mensing, Herford (DE); Gregor Goldberg, Warendorf (DE)

(73) Assignee: Olympus Winter & Ibe GmbH, Hamburg (DE)

(21) Appl. No.: 18/421,720

(22) Filed: Jan. 24, 2024

Related U.S. Application Data
(60) Provisional application No. 63/441,045, filed on Jan. 25, 2023.

(51) Int. Cl. F26B 21/12; F26B 21/00; F26B 25/08

(52) U.S. Cl. CPC F26B 21/12; F26B 21/001; F26B 21/004; F26B 25/08

(57) ABSTRACT

A drying system for drying medical instruments including: a drying chamber configured to receive a medical instrument, a drying gas generation system for providing drying gas, a hose system including a hose through which the drying gas is discharged from the drying gas generation system, and a valve arranged in a wall of the drying chamber, the hose system is connected to the valve for the valve to provide the drying gas into the drying chamber. Wherein the valve is configured to discharge the drying gas exiting the valve into the drying chamber in a main flow direction.

### CROSS-REFERENCE TO RELATED APPLICATIONS

The present application is based upon and claims the benefit of priority from U.S. Provisional Application No. 63/441,045 filed on Jan. 25, 2023, the entire contents of which is incorporated herein by reference.

### FIELD

The present disclosure relates to a drying system for drying medical instruments, and more particularly to a drying system comprising: a drying chamber configured to receive a medical instrument, a drying gas generation system, a hose system including a hose through which gas is discharged from the drying gas generation system, a valve arranged in a wall of the drying chamber, to which valve the hose system is connected and via which the gas provided by the drying gas generation system is conducted into the drying chamber. Furthermore, a method of operating such a drying system is disclosed.

### PRIOR ART

In modern medicine, advanced medical instruments have led to improved diagnostic and therapeutic capabilities. In the process, some advanced medical instruments, such as endoscopes, have evolved into complex devices as a result of long-term improvements. Since the manufacture of such instruments is associated with high costs, there is a desire to reuse the instruments instead of disposing of them after a single use.

Consequently, it is necessary to reprocess the instruments between uses. Reprocessing of endoscopes usually includes cleaning and subsequent disinfection. Typical devices for cleaning and disinfection of medical instruments apply e.g., disinfection and irrigation fluids, pressurized gases like air, heat and other means to the exterior as well as in some cases to interior channels of the instruments. After cleaning and disinfection, the instruments typically undergo a drying process which removes remaining liquids. Such drying process is particularly useful if the instrument is to be stored for some time before it is used again.

The drying process may be executed in the same cleaning and disinfecting device or in a separate drying cabinet, and involves the application of a gas, usually air, conditioned to be of increased temperature, reduced humidity, higher pressure or the like. The drying gas is discharged into the cleaning and drying chamber to absorb remaining moisture. However, the drying capacity is limited e.g., by a maximum permissible temperature for the instruments and a maximum intake of drying gas to the drying chamber. As a result, in complex and difficult to access geometries of the medical instruments, it may be difficult to reliably remove all water residues from the instrument.

However, water residues on the instrument may be detrimental. Increasing the drying time in this case cannot conclusively exclude the presence of such residues and complicates the scheduling for reuse of the instruments.

### SUMMARY

Therefore, an object is to provide a drying system and a method of operating a drying system which are improved with respect to the described problems.

Such object can be achieved by a drying system for drying medical instruments, comprising: a drying chamber configured to receive a medical instrument, a drying gas generation system, a hose system including a hose through which gas is discharged from the drying gas generation system, a valve arranged in a wall of the drying chamber, to which valve the hose system is connected and via which the gas provided by the drying gas generation system is conducted into the drying chamber. Wherein the valve is configured to discharge the gas exiting the valve into the drying chamber in a main flow direction.

In contrast to conventional drying systems, the is configured to apply a directed flow having a main flow direction of drying gas to the drying chamber and the instrument to be dried. Such a directional flow can be characterized by regions of increased flow velocity which, with all other properties of the drying gas remaining unchanged, provides improved evaporation in the areas affected by the increased flow speed. Further, the increased flow velocity of the drying gas can mechanically move liquid residues from complicated geometric surfaces, reducing in even further enhanced drying. At the same time, the limited overall intake of drying gas into the drying chamber is not increased.

The drying system disclosed herein can be configured to be integrated with cleaning and disinfecting systems such that all or at least a plurality of steps for reprocessing a medical instrument can be performed within and by the same device. The system can be configured to dry a single medical instrument or a plurality of medical instruments identical or comparable in construction or different types of medical instruments at the same time. Within this application, a medical instrument is understood to be any kind of instrument used in medical procedures at, on or within a patient, for example, those instruments which can be reused and which, therefore, need reprocessing between different uses.

The drying chamber, in case the drying system can be configured to be integrated with cleaning and disinfecting systems, can be the same chamber in which cleaning and disinfecting processes take place. Such chambers can be of generally cubic shape but is not limited thereto.

In case of separate drying cabinets, the drying chamber can have an elongate shape, in which flexible endoscopes may be positioned in a vertical position, so that removal of water residues from the surface and internal channels may be supported by gravity.

The disclosed drying system is not limited to the use of a single valve discharging gas in a predetermined direction. Rather, a plurality of such valves may be used. Different types of valves including those which do not discharge gas in a predetermined direction or which are not disposed in the wall of the drying chamber may be used in addition as well. Accordingly, the hose system may include a plurality of hoses to supply drying gas to a plurality of valves, respectively, disposed in different locations.

The drying gas generation system can condition gas, for example, air, to be beneficial for performing a drying process. Conditioning steps may comprise heating, adjustment of humidity and other additional or alternative steps. The drying system is not limited to embodiments with a single drying gas generation system but a plurality of such systems for supplying gas to a plurality of valves may be arranged in the drying system as well. Furthermore, among a drying gas generation system as described above, further systems for providing drying gas with different properties or alternative drying means may also be arranged in the system.

The valve represents the border for the drying gas when passing into the drying chamber. It may be arranged on any side wall, ceiling or floor of the drying chamber. The valve may be arranged on a flat wall, curved wall or otherwise shaped wall. The valve may be fixed to the wall by screws through the wall, but any other method of affixing the valve to the wall suitable to withstand the applicable environmental conditions may be used as well.

The valve may comprise an outlet nozzle configured to predetermine the main flow direction of the gas entering the drying chamber. A nozzle can control the direction of a fluid, in this case of the drying gas. The nozzle may be configured to generate a comparably narrow flow cone. The nozzle may alternatively generate a wide flow cone. The configuration may further be such as to provide higher or lower flow velocities. The nozzle may be configured in such a way that it generates a beneficial gas flow according to the medical instruments to be dried.

In an embodiment, the valve may be configured to discharge the drying gas into the drying chamber in such a way that the main flow direction is at an angle to the surface normal of the wall piece in which the valve is arranged. Therein, the angle between the surface normal of the wall and the main flow direction may be greater than or equal to 0 degrees. By providing such valves, a high degree of flexibility for providing the directional gas flow within the drying chamber can be achieved. The configuration of the drying system can be improved according to the desire of providing improved drying capacities in certain regions of the chamber.

According to a further embodiment, the valve may have a nozzle tappet configured to, in a first position, close the nozzle and prevent fluidic communication between the hose system and the drying chamber. Thus, in the first position, the nozzle tappet can prevent drying gas from discharging into the drying chamber. In turn, the ingress of moisture from the drying chamber into the valve and the hose system can also be avoided in the first position. Moving the nozzle tappet away from the first position can open the valve and allows a fluid communication between the hose system and the drying chamber.

Further, the nozzle tappet may be biased by a spring such that the nozzle tappet is held in the first position in an unloaded state. Thus, without applying any additional forces, the valve can remain closed and no fluidic communication between the hose system and the drying chamber is possible. A force can be applied to the nozzle tappet to establish fluidic communication and to allow a discharge of drying gas into the chamber.

The valve can comprise means for adjusting the biasing force of the spring. Such means may be provided by a spacer of adjustable length in order to allow for different spatial elongation of the spring in the first position which results in different spring forces. Alternatively, the spacer may be structurally coupled to a thread. By turning the thread, the position of the spacer relative to the nozzle tappet can be adjusted which, in turn, defines the space to which the spring is compressed in the biased state in the first position. Thus, by adjusting the biasing force of the spring, a force required to open the valve can be adjusted as well.

In an embodiment, the gas applied to the valve by the drying gas generation system via the hose system can act against the spring forces biasing the nozzle tappet, so that the valve opens above an opening pressure and the gas flows into the drying chamber. Consequently, providing a sufficient pressure through the drying gas generation system can suffice to open the valves and allow discharge of conditioned drying gas into the drying chamber. The ingress of moisture into the hose system can be prevented as the valve is only opened when a pressure drop between the hose system and the drying chamber is established which causes flow towards the chamber.

In another embodiment, the valve may comprise a flange configured to seal an opening in the wall of the drying chamber in which the valve is arranged. The flange may extend around the passageway in the wall through which the valve is arranged. At the same time, the flange may cover the means for fixation, e.g., screws, by which the valve is mounted to the wall. The flange may comprise a sealing groove in which sealing means are arranged. Such sealing means, e.g., O-rings, may improve the sealing capacity of the flange. At the same time, they can represent comparatively easy means of providing tightness against the leakage of moisture out of the drying chamber.

The drying chamber may be configured to receive the medical instrument in a specific position. A known position of the medical instrument to be dried simplifies the predetermination of the main flow direction of the drying gas as critical areas of interest to be dried are known more precisely beforehand. The drying system may comprise a holding device for positioning the medical instrument inside the drying chamber. A corresponding holding device may allow for a precise positioning of the instrument within the drying chamber further facilitating the predetermination of the main flow direction.

The main flow direction may be chosen in such a way that the gas discharging into the drying chamber can impinge on a specific area of the medical instrument to be dried. Such specific areas may be those of a complex geometry where drying by other means is difficult or areas in which a sufficient removal of remaining liquids and residues is critical for quickly providing the instrument for reuse or longevity. The specific area of the medical instrument to be dried may comprise at least one of a handpiece, a plug, a cable, or an operating element of the medical instrument. These regions are typically characterized by a geometry of increased complexity. In conventional drying systems, water residues may e.g., remain between and below buttons and knobs, from where it can more efficiently be removed by the directional drying gas flow.

In another embodiment, the hose system may comprise a manifold in which gas provided by the drying gas generation system is distributed to a plurality of hoses. A single drying gas generation system may, thus, be used to provide drying gas for a plurality of valves.

In addition, a measuring circuit may be arranged in at least one of the manifold or the drying gas generation system, wherein the measuring circuit is configured to measure properties of the drying gas and to direct the measured property to a controller configured to control the drying gas generation system such that the property is maintained in a desired range. Properties of interest of the conditioned gas may include temperature, humidity, the overall volumetric flow rate, and others. All these properties of the drying gas may be predetermined, and controlled e.g., by feedback control means in order to maintain the desired level. The property range may also be defined dynamically depending on other process parameters.

The object can be achieved by a method of operating a drying system for drying medical instruments, comprising the steps of: providing a medical instrument in a drying chamber of the drying system; providing drying gas by a drying gas generation system; discharging the drying gas into the drying chamber, wherein the drying gas is discharged through valves configured to discharge the gas exiting the valve into the drying chamber in a main flow direction. Regarding the advantages of the method compared to the prior art, reference is made to the specification made above.

Providing the medical instrument in the drying chamber of the drying system may comprise providing the medical instrument in a specific position within the drying chamber. Providing the medical instrument in the drying chamber of the drying system may comprise arranging the medical instrument in a holding device inside the drying chamber.

Discharging the drying gas into the drying chamber in a main flow direction may comprise discharging the drying gas in such a way that the gas discharging into the drying chamber impinges on a specific area of the medical instrument to be dried. Impinging on a specific area of the medical instrument to be dried may comprise impinging on at least one of a handpiece, a plug, a cable, or operating elements of the medical instrument. Again, reference is made to the above regarding the advantages of all these embodiments.

### BRIEF DESCRIPTION OF DRAWINGS

Embodiments are described below with reference to a number of figures, the figures being illustrative in nature and intended to aid understanding of the embodiments without limiting it. Where applicable, the figures are not to be understood as a representation to scale of the claimed devices and systems.

In the drawings:

FIG. 1 illustrates a drying system for drying medical instruments;

FIGS. 2a and 2b illustrate a valve of such a drying system; and

FIG. 3 shows an illustrative method.

### DETAILED DESCRIPTION

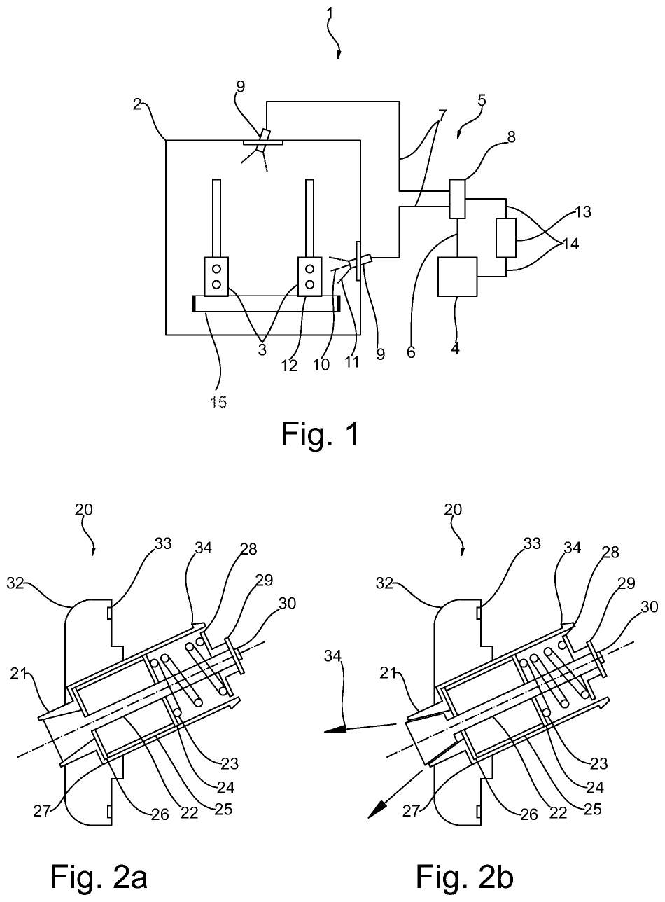

FIG. 1 is an illustration of a system 1 for drying medical instruments. The system comprises a drying chamber 2 in which for the purpose of illustration two medical instruments 3 are disposed. The system 1 may, however, also be configured to dry a single medical instrument or a plurality of medical instruments identical or comparable in construction or different types of medical instruments at the same time. In the illustrated case, the medical instruments are endoscopes, although other types of instruments may be dried by the system as well.

The system further comprises a drying gas generation system 4. The drying gas generation system 4 conditions a drying gas, like air, to be beneficial for performing a drying process. Conditioning steps may comprise heating, adjustment of humidity, and other additional or alternative steps. The drying gas generation system 4 can comprise a source of gas, such as a pressurized tank holding air or a suitable gas such as Nitrogen, Carbon Dioxide, or the like. Alternatively, the drying gas generation system 4 can comprise a pump for providing pressurized ambient air. The drying gas generation system may further comprise one or more of a filter, a de-humidifier, a heater, and the like.

Drying gas is then fed into the drying chamber 2 through a hose system 5. The hose system 5 comprises a plurality of hoses 6, 7 and a manifold 8. Drying gas conditioned by the drying gas generation system 4 is first fed through a first hose 6 into the manifold 8 from where it is passed through a plurality of hoses 7 to a plurality of valves 9 from where the drying gas is discharged into the drying chamber 2.

A detailed description of the valves 9 can be found below with reference to FIGS. 2a, 2b. In the present example, two valves 9 are illustrated which are configured to discharge the gas exiting the valves 9 into the drying chamber in a main flow direction 10 illustrated by a dashed line. In the illustrated example, the drying gas flows away from the valve 9 in a conical shape 11. The conical shape may be wider or narrower according to the design of the valves 9, but other shapes may also be generated with other types of valves.

The directed flow having a main flow direction 10 of drying gas discharging into the drying chamber 2 is characterized by regions of increased flow velocity which, with all other properties of the drying gas remaining unchanged, provides improved evaporation in the areas affected by the increased flow speed compared to conventional drying systems. The main flow direction 10 may be configured such that the gas discharging into the drying chamber 2 impinges on a specific area of the medical instrument 3 to be dried. Such specific areas may those of a complex geometry where drying by other means is difficult or areas in which a sufficient removal of remaining liquids and residues is critical for quickly providing the instrument for reuse or longevity. The specific area of the medical instrument 3 to be dried comprises, in the illustrated example, a handpiece 12 of the instrument 3 with a plurality of operating elements. Instead or additionally, other specific areas may be targeted as well.

While in the illustrated example two valves 9 discharging the gas in a main flow direction are illustrated, the drying system 1 is not limited to such a configuration. Rather, a single or a plurality of such valves 9 may also be used. Different types of valves including those which do not discharge gas in a predetermined direction or which are not disposed in the wall of the drying chamber may be used in addition as well. Accordingly, the hose system 5 may include a larger or smaller number of hoses 7. The use of a manifold 8 is optional.

In the example of FIG. 1, two valves 9 are arranged on two sides of the drying chamber 2. The valves 9 may be arranged on any side wall, ceiling or floor of the drying chamber. The valves 9 may be arranged on a flat wall, curved wall or otherwise shaped wall.

The illustrated drying system 1 may at the same time be configured to be integrated with cleaning and disinfecting systems such that all or at least a plurality of steps for reprocessing a medical instrument 3 can be performed within and by the same device. The drying chamber 2 may in this case be a cleaning chamber of such a cleaning and disinfection system. In this case, additional systems for providing disinfectants or irrigation fluids or connections for flushing interior channels of the instruments may be provided. These systems are not illustrated in FIG. 1. In other embodiments not shown in the drawings, the drying chamber may be part of a separate drying cabinet, into which a medical instrument can be transferred after cleaning and disinfection is completed.

The drying chamber 2 may further be configured to receive the medical instrument 3 in a specific position. For this purpose, the medical instrument may be arranged in a holding device 15 inside the drying chamber 2. In the drying chamber 2, the medical instruments 3 may be disposed on or held by the holding device 15, which can comprise a rack, a tray, a wire basket, or any other suitable means for securely holding the medical instruments 3 while providing as little surface contact as possible, so that access of the drying gas to the surface of the medical instruments 3 is minimally impeded.

In the example of FIG. 1, an optional measuring circuit (i.e., sensor) (not shown) configured to measure properties of the drying gas is arranged in the manifold 8. The measured property is communicated to a controller 13 configured to control the drying gas generation system 4 such that the property maintains a desired range. The controller comprising hardware, such as a CPU, computer, PLC or dedicated circuit(s). In the example, communication between the measuring circuit in the manifold 8, the controller 13 and the drying gas generation system 4 takes place via electrical connections 14 although other communication means both wired and non-wired are possible as well.

The measurement circuit may as well be arranged in the drying gas generation system 4 or in another part of the hose system 5. Properties of interest of the conditioned gas to be measured by the measurement circuit and controlled by the controller 14 may include temperature, humidity, the overall volumetric flow rate, and others, using for example, temperature sensor, humidity sensor and flow sensor, respectively. All these properties of the drying gas may be predetermined, and controlled e.g., by feedback control with the controller 14 in order to maintain the desired level. The property range may also be defined dynamically depending on other process parameters.

FIG. 2a is an illustration of a valve 20 which may be used in a system. The valve 20 may be used as one or both of valves 9 of FIG. 1. The valve 20 comprises a nozzle 21 configured to define a main flow direction of the gas entering a drying chamber, e.g., drying chamber 3, to the left of nozzle 21 in FIG. 2a. The valve 20 further comprises a nozzle tappet 22 in a first position. In this first position, nozzle tappet 22 is configured to close the nozzle 21 and prevent fluidic communication between the hose system, e.g., hose system 5, and the drying chamber. Thus, in the first position, nozzle tappet 22 prevents drying gas from discharging into the drying chamber. In turn, the ingress of moisture from the drying chamber into the valve and the hose system is also avoided in the first position.

In the illustrated example, valve 20 further comprises a spring 23. Spring 23 is biased as it is arranged in this example between a first tappet guide 24, which rests via a first distance element (stop) 25 and a second tappet guide 26 on the valve housing 27, and a second distance element (stop) 28. Distance element 28 is secured to the nozzle tappet 22 via a disk element 29 and a screw 30. The spring 23 holds nozzle tappet 22 in the first position (FIG. 2a) in an unloaded state.

The valve 20 further comprises a flange 32. The flange 32 can seal an opening in the wall of the drying chamber in which the valve 20 is arranged. The illustrated flange extends around the passageway in the wall (not shown) through which the valve 20 is arranged. The flange 32 can be made from several parts, e.g., as to cover means for fixation fixing the valve 20 to the wall of the drying chamber. In this case, flange 32 may comprise of an underlying part connected to the valve housing 27 which is fixed, e.g., by means of screws, to the wall. A second covering part of the flange 32 may then be snapped on the first part covering the screws. For reasons of simplicity, this is not illustrated in FIGS. 2a, 2b. Flange 32 further comprises an optional sealing groove 33 in which sealing means (such as O-ring seals) (not shown) are arranged.

For establishing supply of drying gas to the valve 20, the valve housing 27 is configured to comprise a hook-like structure 34 onto which a hose of the hose system, e.g., hose system 5, can be slipped. The hose can then be secured to the valve e.g., by means of a hose clamp.

FIG. 2b illustrates valve 20 of FIG. 2a in an open state, when drying gas is supplied to the valve 20 through the hose system, such that the gas acting on the nozzle tappet 22 is of sufficient pressure to overcome the spring force of spring 23 and to move nozzle tappet 22 away from the first position. This opens an annular space between the nozzle 21 and the nozzle tappet 22, through which drying gas can discharge into the drying chamber as indicated by arrows 34.

In FIGS. 2a, 2b, the valve housing 27 is connected to the flange 32 and consequently to the wall of the drying chamber (not shown) at a predetermined angle, defining the main flow direction of the drying gas discharging into the drying chamber. Valves 20 may however also be configured to provide a different angle to the surface normal of the wall piece in which the valve 20 is arranged. The angle may be greater than or equal to 0 degrees.

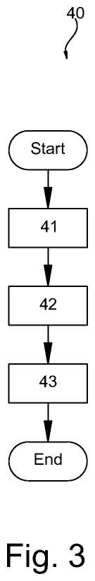

FIG. 3 illustrates a method 40 of operating a drying system for medical instruments. After the start, the method 40 comprises a step 41 of providing a medical instrument in a drying chamber of the drying system. Within this context, providing the medical instrument in the drying chamber of the drying system may comprise providing the medical instrument in a specific position within the drying chamber. For this purpose, the medical system may be arranged in a holding device inside the drying chamber.

At step 42, the method comprises a step of providing drying gas by a drying gas generation system. The drying gas generation system conditions gas to be beneficial for performing a drying process. Conditioning steps may comprise e.g., heating, adjustment of humidity and other additional or alternative steps.

Step 43 comprises discharging the drying gas into the drying chamber, wherein the drying gas is discharged through valves configured to discharge the gas exiting the valve into the drying chamber in a main flow direction. Within this step, discharging the drying gas into the drying chamber in a main flow direction may comprise discharging the drying gas in such a way that the gas discharging into the drying chamber impinges on a specific area of the medical instrument to be dried. In doing so, impinging on a specific area of the medical instrument to be dried may comprise impinging on at least one of a handpiece, a plug, a cable, or operating elements of the medical instrument.

While there has been shown and described what is considered to be embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that can fall within the scope of the appended claims.

1. A drying system for drying medical instruments, the drying system comprising:
a drying chamber configured to receive a medical instrument,
a drying gas generation system for providing drying gas,
a hose system including a hose through which the drying gas is discharged from the drying gas generation system, and
a valve arranged in a wall of the drying chamber, the hose system is connected to the valve for the valve to provide the drying gas into the drying chamber,
wherein the valve is configured to discharge the drying gas exiting the valve into the drying chamber in a main flow direction.

2. The drying system of claim 1, wherein the valve comprises an outlet nozzle configured to predetermine the main flow direction of the drying gas entering the drying chamber.

3. The drying system of claim 2, wherein the valve is configured to discharge the drying gas into the drying chamber such that the main flow direction is at an angle to the surface normal of the wall on which the valve is arranged.

4. The drying system of claim 3, wherein the angle between the surface normal of the wall and the main flow direction is greater than or equal to 0 degrees.

5. The drying system of claim 1, wherein the valve has a nozzle tappet configured in a first position to close the nozzle and prevent fluidic communication between the hose system and the drying chamber.

6. The drying system of claim 5, wherein the nozzle tappet is biased by a spring such that the nozzle tappet is held in the first position in an unloaded state.

7. The drying system of claim 5, wherein the valve comprises means for adjusting the biasing force of the spring.

8. The drying system of claim 6, wherein the drying gas applied to the valve by the drying gas generation system via the hose system acts against a spring force biasing the nozzle tappet, so that the valve opens above a predetermined opening pressure and the drying gas flows into the drying chamber.

9. The drying system of claim 1, wherein the valve comprises a flange configured to seal an opening in the wall of the drying chamber in which the valve is arranged.

10. The drying system of claim 9, wherein the flange comprises a sealing groove configured to hold a seal.

11. The drying system of claim 1, wherein the drying chamber is configured to receive the medical instrument in a specific position.

12. The drying system of claim 1, further comprising a holding device disposed within the drying chamber, wherein the medical instrument is arranged in the holding device inside the drying chamber.

13. The drying system of claim 1, wherein a direction of the main flow direction is such that the drying gas discharging into the drying chamber impinges on a specific area of the medical instrument to be dried.

14. The drying system of claim 13, wherein the specific area of the medical instrument to be dried comprises at least one of a handpiece, a plug, a cable, or an operating element of the medical instrument.

15. The drying system of claim 1, wherein the valve comprises a plurality of valves and the hose system comprises a plurality of hoses respectively corresponding to the plurality of valves, and
further comprising a manifold in which the drying gas provided by the drying gas generation system is distributed to the plurality of hoses.

16. The drying system of claim 15, further comprising a measuring circuit arranged in at least one of the manifold, the hose system or the drying gas generation system, wherein the measuring circuit is configured to measure properties of the drying gas and to direct the measured property to a controller configured to control the drying gas generation system such that the property maintains a desired range.

17. A method of operating a drying system for drying medical instruments, the method comprising:
providing a medical instrument in a drying chamber of the drying system;
providing drying gas into the drying chamber from a drying gas generation system; and
discharging the drying gas into the drying chamber, wherein the drying gas is discharged through a valve configured to discharge the drying gas exiting the valve into the drying chamber in a main flow direction.

18. The method of claim 17, wherein the providing of the medical instrument in the drying chamber of the drying system comprises providing the medical instrument in a specific position within the drying chamber.

19. The method of claim 17, wherein the providing of the medical instrument in the drying chamber of the drying system comprises arranging the medical instrument in a holding device inside the drying chamber.

20. The method of claim 17, wherein the discharging of the drying gas into the drying chamber in a main flow direction comprises discharging the drying gas in such a way that the drying gas discharging into the drying chamber impinges on a specific area of the medical instrument to be dried.

21. The method of claim 19, wherein the impinging on a specific area of the medical instrument to be dried comprises impinging on at least one of a handpiece, a plug, a cable, or operating elements of the medical instrument.
